(19) United States
(12) Patent Application Publication
(10) Pub. No.: US 2012/0125452 A1
(43) Pub. Date: May 24, 2012

(54) Pressure regulator with modular stabilizing mass

(76) Inventor: Arno Drechsel, Lienz (AT)

(21) Appl. No.: 13/380,876

(22) PCT Filed: Jul. 9, 2010
(86) PCT No.: PCT/IB10/53148

§ 371 Date: Feb. 8, 2012

(30) Foreign Application Priority Data
Jul. 10, 2009 (IT) VI2009A000171

(51) Int. Cl. F16K 21/04

(52) U.S. Cl. 137/511

(57) ABSTRACT

A flow through pressure regulator (1) for irrigation systems comprises a main body (2) defining an axis (X) with an inlet (3) and an outlet (4) for irrigation water and a stabilizing mass (6). The latter includes a plurality of modular weights (7, 7′, 7″ . . . ) that are adapted to be removably associated with the outer surface (5) of the main body (2) to allow a user to adjust the stabilizer mass (6) without requiring removal of the system regulator.

### FIELD OF THE INVENTION

The present invention finds application in the field of irrigation devices and particularly relates to a liquid pressure regulator device.

### BACKGROUND ART

Irrigation systems, such as the so-called “center pivot” systems are known to use pressure regulating devices to maintain the outlet pressure of irrigation liquid at a substantially constant level.

These systems may consist of lines, possibly as long as hundreds of meters, with liquid outlet pipes branching therefrom. A pressure regulator and a sprinkler device downstream therefrom are typically fitted at the end of each pipe, to appropriately direct flow.

These prior art regulators, generally known as “flow through” regulators, have an elongate body, defining a longitudinal axis, for irrigation water to pass therethrough.

One of the problems associated with the use of pressure regulators in “center pivot” systems is that they are prone to oscillations and vibrations, caused by the flow itself, the wind and the stresses induced by the downstream sprinkler, when they are coupled to flexible down pipes.

In order to minimize such vibrations and oscillations, stabilizer collar solutions are known, which are designed to be axially slideably fitted onto the main body.

Nevertheless, these solutions have the well-known drawback of not allowing easy adjustment of the stabilizer mass. Should any changed operating and/or environmental condition require mass adjustment, this would involve shutting down the system, removing the regulator, slipping the current collar off, replacing it with the collar of different mass, fitting the assembly back to the corresponding down pipe and starting the system again.

This will obviously involve huge time and money consumption, as well as the risk of damages to the system or parts thereof, due to abrupt vibrations and oscillations and continuous on/off transients.

Another drawback of prior art solutions is that the user is required to have a number weight stabilizing collars of different weights, with an inevitable cost increase.

### DISCLOSURE OF THE INVENTION

The object of the present invention is to at least partially obviate the above drawbacks, by providing a liquid pressure regulating device, particularly for use in irrigation systems, that is highly efficient and relatively cost-effective.

A particular object is to provide a regulator device that allows adjustment of the stabilizer mass without requiring removal thereof from the system.

A further particular object is to provide a pressure regulator that allows adjustment of the stabilizer mass according to the needs and/or specifications of the various systems.

Yet another object is to provide a pressure regulator that allows easier adjustment of the stabilizer mass as compared with prior art regulators.

A further important object of the invention is to provide a pressure regulator that preserves the structural integrity of the system with which it is connected.

These and other objects, as better explained hereafter, are fulfilled by a flow through pressure regulator as defined in claim 1.

The regulator may include a main elongated body, defining a longitudinal axis, with an inlet and an outlet for irrigation water.

A stabilizer mass may be attached to the main body, which mass includes or is composed of a plurality of modular weights.

With this feature, a user can easily adjust the modular stabilizer mass by simply changing the number of modular weights or modules.

Whenever the stabilizer mass were to be adjusted during operation of the system, e.g. due to stronger winds, the user shall simply change the number of modular weights or modules attached to the outer surface of the regulator.

Advantageously, the modular weights or modules may have substantially identical masses and/or shapes, for simpler adjustment of the desired stabilizer mass.

Conveniently, the modular weights or modules may be removably attached to the outer surface of the main body.

The outer surface can be readily accessed from the outside by a user, thereby allowing the modular stabilizer mass to be adjusted without removing the regulator from the system, and affording time and money savings and minimized risk of damages to the system or its parts.

Such removable attachment is obtained by providing the modular weights and the main body of the regulator, particularly its outer surface, with appropriate removable mutual fastening means.

Preferably, the outer surface of the main body of the regulator may include a plurality of fastening members, such as hooks, clips or else, each being adapted to have a corresponding individual modular weight attached thereto, preferably by appropriate means for fixation to said fastening members.

In a preferred, non-limiting embodiment of the invention, the fastening members may be evenly arranged over the outer surface.

This feature allows more effective balancing of the stabilizer mass, particularly when the modular weights have identical masses.

Advantageously, the regulator may include means for radially and/or rotationally and/or axially locking the modular weights attached to the fastening members, to prevent any mutual abrupt movements.

Advantageous configurations of the invention will be defined in the dependent claims.

### BRIEF DESCRIPTION OF THE DRAWINGS

Further features and advantages of the invention will be more apparent from the detailed description of a preferred, non-exclusive embodiment of a pressure regulator device of the invention, which is described as a non-limiting example with the help of the annexed drawings, in which:

FIG. 1 is a perspective view of a pressure regulator 1 of the invention;

FIG. 1a is a perspective view of a modular weight 7;

FIG. 2 is a top view of the main body 2 of the pressure regulator 1 of the invention;

FIG. 3 is a partially exploded perspective view of a pressure regulator 1 of the invention;

FIGS. 4a, 4b, 4c and 4d are perspective views of a few embodiments of the pressure regulator of the invention;

FIGS. 5 and 6 are perspective views of an embodiment of a sprinkler 100 having a modular stabilizer mass.

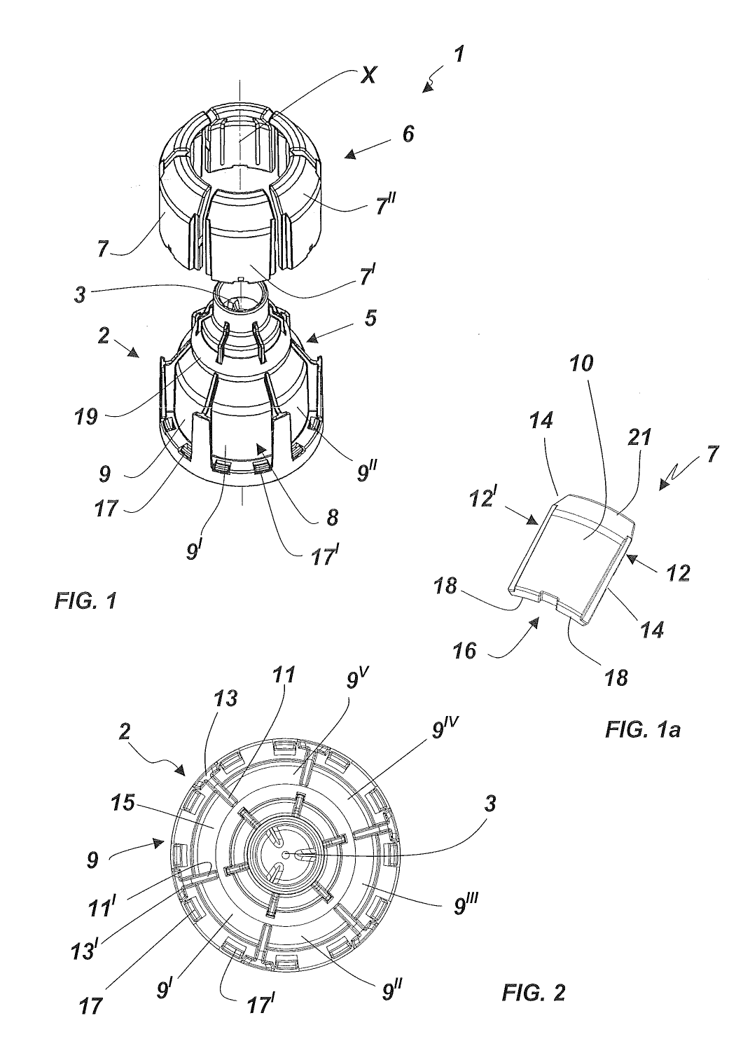

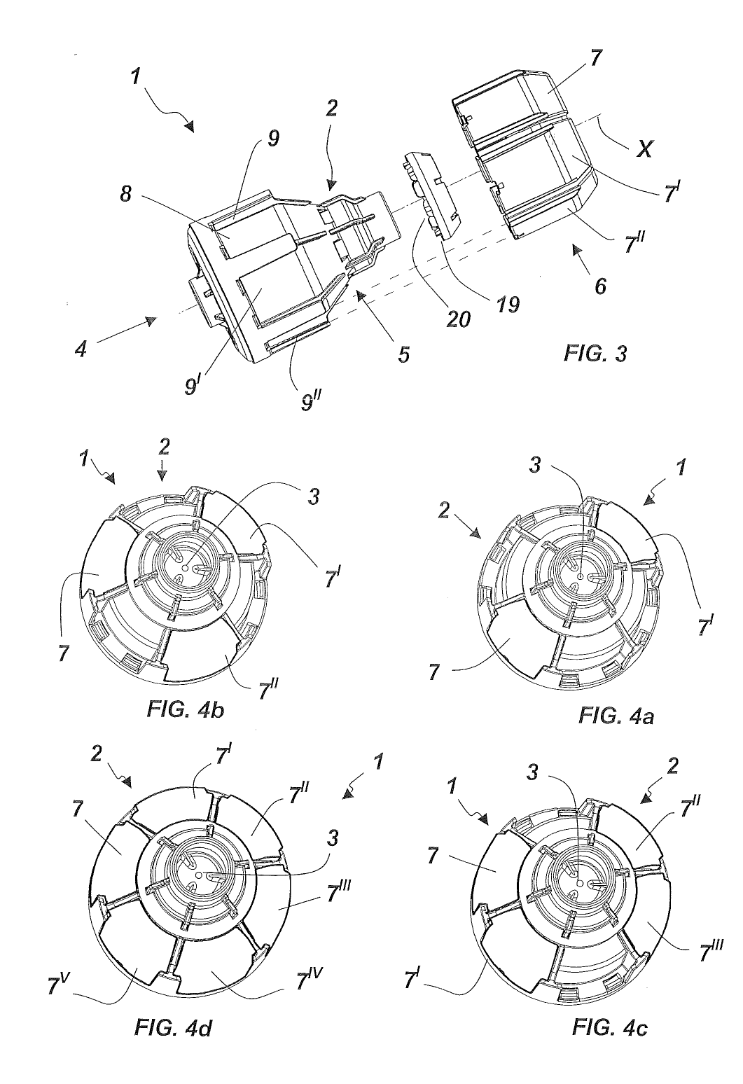

### DETAILED DESCRIPTION OF A PREFERRED EMBODIMENT

Referring to the annexed figures, a flow through pressure regulator 1 is shown, which can be advantageously mounted to the down pipe of “center pivot” irrigation systems. The pressure regulator 1 may be placed upstream from a sprinkler device for appropriately directing the flow.

Basically, the regulator 1 may include a main elongate body 2, defining a longitudinal axis X, with an inlet 3 and an outlet 4 for irrigation water flowing in from the down pipe.

As is known per se, the regulator 1 will regulate water pressure at the inlet 3 by supplying water at the outlet 4 at substantially constant pressure, even in case of pressure variations in inlet water.

Advantageously, the regulator 1 may have an interior construction as taught in the Italian Patent application VI2004A000170, by the applicant hereof, which may be consulted for reference.

Exteriorly, the main body 2 may have an outer surface, generally designated by numeral 5, which is adapted to be fitted with a stabilizer mass, generally designated by numeral 6, to stabilize the regulator 1.

The stabilizer mass 6 may include or be composed of a plurality of modular weights 7, 7′, 7″ . . . to be removably attached to the outer surface 5.

Any number of modular weights 7, 7′, 7″ may be provided, e.g. six. Also, the modular weights 7, 7′, 7″ . . . may have the same mass and/or shape. In the embodiment described herein by way of illustration and without limitation, each of the six modular weights 7, 7′, 7″ . . . may be a quarter pound.

For the modular weights 7, 7′, 7″ . . . to be removably attached to the outer surface 5, preferably at the generally cylindrical portion 8, appropriate fastening members may be provided, which may consist, in the preferred, non limiting embodiment as described herein, of appropriate seats 9, 9′, 9″ . . . of such shape and size that each of them can receive, preferably in interlocked relation, a single modular weight 7, 7′, 7″ . . . adapted to be slideably fitted therein.

For easy distribution of the stabilizer mass, the seats 9, 9′, 9″ . . . are evenly arranged along the cylindrical portion 8 of the surface 5. In the preferred, non limiting embodiment as described herein, there may be six of them, i.e. as many as the modular weights 7, 7′, 7″ . . . , all having the same size and being in contiguous positions.

Thus, with identical weights 7, 7′, 7″ . . . , the user may compose the stabilizer mass according to his/her requirements, by simply changing the number of modular weights 7, 7′, 7″ . . . FIGS. 4a to 4d show examples of ½ pound, ¾ pound, 1 pound and 1 and ½ pound stabilizer masses respectively. Preferably, the modular weights 7, 7′, 7″ . . . will be distributed in their seats 9, 9′, 9″ . . . in an even manner, to prevent imbalance.

Advantageously, the seats 9, 9′, 9″ . . . may have such a size and shape as to allow the modular weights 7, 7′, 7″ . . . to interlockingly fit therein. For this purpose, the modular weights 7, 7′, 7″ . . . may have a generally plate-like fitting portion 10, 10′, 10″ . . . , whereas the seats 9, 9′, 9″ . . . may have a shape substantially complementary thereto.

With this particular configuration, each modular weight 7, 7′, 7″ . . . will be radially, rotationally and axially locked in its seat 9, 9′, 9″ . . . .

Particularly, each of the seats 9, 9′, 9″ . . . may include a pair of side walls 11, 11′, adapted for engagement with corresponding side faces 12, 12′ of the corresponding modular weight 7, 7′, 7″ . . . for rotatably locking them in the seats 9, 9′, 9″ . . . .

Also, each of the side walls 11, 11′ may conveniently include a projection 13, 13′ susceptible of engaging with a corresponding groove 14, 14′ that is formed at the side walls 12, 12′ for radially locking each modular weight 7, 7′, 7″ . . . in its seat 9, 9′, 9″ . . . .

Furthermore, each of the seats 9, 9′, 9″ . . . may advantageously include a bottom wall adapted for engagement with corresponding lower end 16 of the corresponding modular weight 7, 7′, 7″ . . . for axially locking them in the seats 9, 9′, 9″ . . . .

In a preferred non limiting embodiment, each of the bottom walls 15 includes a pair of openings 17, 17′ for receiving corresponding projections 18, 18′ of the lower end 16 of each of the modular weights 7, 7′, 7″ . . . to axially, rotationally and radially lock them in the seats 9, 9′, 9″ . . . .

Optionally, the regulator 1 may include an annular member 19 which is adapted to be slideably fitted onto the main body 2 and has a lower surface 20 adapted for engagement with the corresponding upper ends 21 of the modular weights 7, 7′, 7″ . . . for axially locking them in the seats 9, 9′, 9″ . . . .

The above disclosure clearly shows that the invention fulfills the intended objects and particularly meets the requirement of providing a pressure regulator that allows very easy adjustment of the stabilizer mass 6, without removing the regulator.

Another advantage of the regulator of the invention is that the modular stabilizer mass does not require storage of multiple parts of different weights, thereby minimizing costs for the user.

A further advantage of the regulator of the invention is that the modular stabilizer mass minimizes the wind-exposed surface.

Yet another advantage of the regulator of the invention is that it allows adjustment of the stabilizer mass according to the needs and/or specifications of the various systems.

The regulator of this invention is susceptible to a number of changes and variants, within the inventive concept disclosed in the appended claims. All the details thereof may be replaced by other technically equivalent parts, and the materials may vary depending on different needs, without departure from the scope of the invention.

While the regulator has been described with particular reference to the accompanying figures, the numerals referred to in the disclosure and claims are only used for the sake of a better intelligibility of the invention and shall not be intended to limit the claimed scope in any manner.

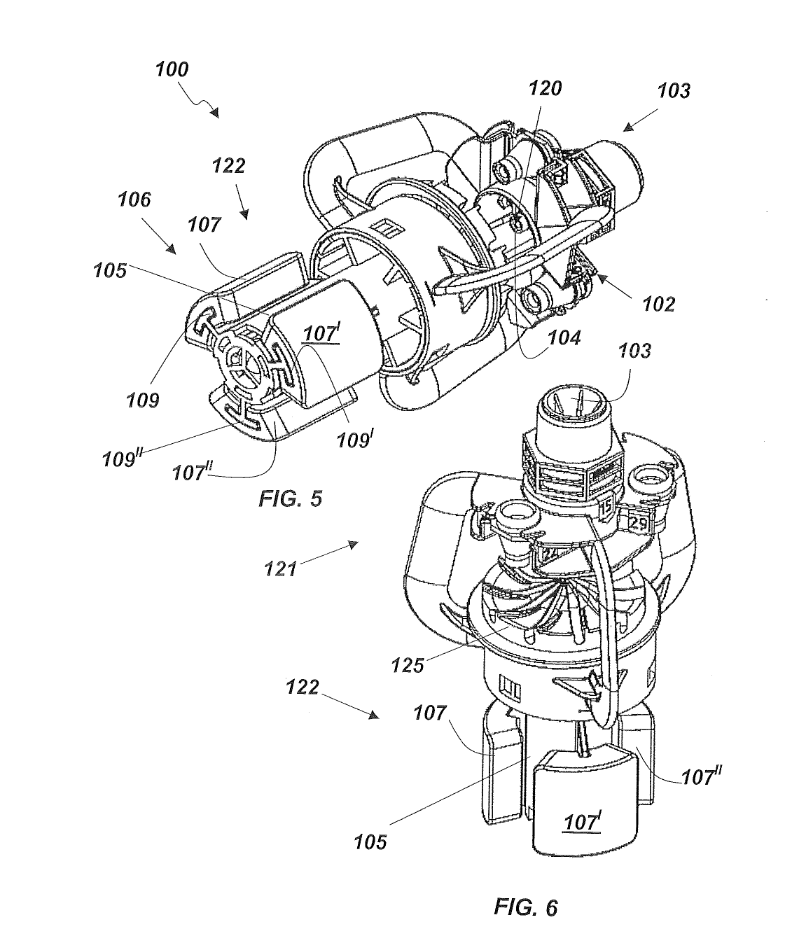

As shown in FIGS. 5 and 6, the same inventive principle encompasses a sprinkler device 100, of the type that can be installed in a “center pivot” irrigation system downstream from a pressure regulator.

The sprinkler 100 may include a main body 102, with an inlet 103 and an outlet 104 for irrigation water. The main body 102 may further include a nozzle 120 for controlling outflow and setting the irrigation range. The nozzle 120 faces toward a plate 125, which is configured to optimize irrigation water distribution.

Preferably, the sprinkler 101 may be designed as taught in one or more of patent applications VI2008A000174, VI2008A000175, VI2008A000176, which may be consulted for reference.

A stabilizer mass 106 may be attached to the main body 101, which mass includes or is composed of a plurality of modular weights 107, 107′, 107″ . . . respectively.

Advantageously, the modular weights or modules 107, 107′, 107″ . . . may have substantially identical masses and/or shapes, for simpler adjustment of the desired stabilizer mass 106.

Conveniently, the modular weights or modules 107, 107′, 107″ . . . may be removably attached to the outer surface 105 of the main body 102, in the upper portion 121 and/or lower portion 122 thereof.

Otherwise, the modular weights or modules may be removably attached to the interior of the main body 102, e.g. to the interior part of the outer surface 105.

Such removable attachment is obtained by providing the modular weights 107, 107′, 107″ . . . and the main body 102 of the sprinkler 101, particularly its outer surface 105, with appropriate removable mutual fastening means.

Preferably, the outer surface 105 of the main body 102 of the sprinkler 101 may include a plurality of fastening members 109, 109′, 109″ . . . , such as hooks, clips or else, each being adapted to have a corresponding individual modular weight 107, 107′, 107″ . . . attached thereto, preferably by appropriate means for fixation to said fastening members.

In a preferred, non-limiting embodiment of the invention, the fastening members 109, 109′, 109″ . . . may be evenly arranged over the outer surface 105.

Advantageously, the sprinkler may include means for radially and/or rotationally and/or axially locking the modular weights 107, 107′, 107″ . . . attached to the fastening members 109, 109′, 109″ . . . .

The invention claimed is:

1. A flow through pressure regulator for irrigation systems, comprising:
a) a main elongated body defining a longitudinal axis, said main body having an inlet and an outlet for irrigation water, said main body further having an outer surface; and
b) a stabilizing mass comprising a plurality of modular weights that are adapted to be removably attached to said outer surface of said main body to allow a user to adjust stabilizer mass as needed.

2. The regulator as claimed in claim 1, wherein said outer surface comprises a plurality of fastening members, each adapted to have a corresponding modular weight of said plurality anchored thereto.

3. The regulator as claimed in claim 2, wherein said outer surface has a generally cylindrical portion with said fastening members evenly arranged thereon.

4. The regulator as claimed in claim 1, wherein said modular weights have substantially a same mass and/or shape.

5. The regulator as claimed in claim 2, further comprising means for radially, rotationally, or axially locking the modular weights attached to the fastening members.

6. The regulator as claimed in claim 2, wherein said fastening members comprise adjacent seats, each adapted to have a corresponding modular weight slideably fitted therein.

7. The regulator as claimed in claim 6, wherein each of said modular weights has at least one generally plate-shaped fitting portion, each of said seats having a shape complementary to that of said at least one generally plate shaped fitting portion.

8. The regulator as claimed in claim 7, wherein each of said seats includes a pair of side walls, adapted for engagement with corresponding side faces of each of said modular weights for rotatably locking said modular weights in said seats.

9. The regulator as claimed in claim 8, wherein each of said side walls of said seats comprises a projection, susceptible of engaging with a corresponding groove of said side faces of each of said modular weights for rotatably locking said modular weights in said seats.

10. The regulator as claimed in claim 9, wherein each of said seats comprises a bottom wall adapted for engagement with a corresponding lower end of said modular weights for axially locking said modular weights in said seats.
